(19) United States
(12) Patent Application Publication
(10) Pub. No.: US 2008/0158357 A1
(43) Pub. Date: Jul. 3, 2008

(54) APPARATUS FOR DRIVER ANALYSIS USING REARVIEW MIRROR

(75) Inventors: Jonathan H. Connell, Cortlandt Manor, NY (US); Vit Libal, Ossining, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/619,324

(22) Filed: Jan. 3, 2007

(51) Int. Cl. H04N 7/18

(52) U.S. Cl. 348/148; 348/E07.085

(57) ABSTRACT

A driver analysis system for a vehicle includes a video camera producing a video signal mounted in or on a body of the vehicle, the video camera having a field of view that includes a rearview mirror, and the video camera being positioned such that it sees a face of a driver of the vehicle reflected by the rearview mirror when the mirror is aligned to allow the driver to see behind the vehicle, a processing unit receiving a video signal from the video camera, where the processing unit includes a video grabber/digitizer, which receives the video signal from the camera and produces a sequence of digitized images, a central processing unit, a memory, and an output control line, and a control program, that runs on the processing unit, comprising image recognition algorithms that are capable of detecting the face of the driver in the image sequence.

### BACKGROUND OF THE INVENTION

1. Field of the Invention

The present invention relates to a method and apparatus for analysis of the driver through the reflection in the rearview mirror. More particularly, the present invention is directed to a method of automatically adjusting the rearview mirror in a vehicle according to the position of the driver's face. Additionally, the present invention is directed to spatial arrangement of an image acquisition system for camera-aided automatic speech recognition and driver drowsiness detection in a vehicle.

2. Description of the Related Art

Certain conventional systems have been designed that use ceiling mounted cameras and rearview mirror reflected images to identify a face of the driver for security purposes. Such systems have been used in vehicle theft protection applications.

Other conventional systems include automatic rearview mirror adjustment systems that turn the rearview mirror in response to the vehicle's navigation system to compensate for the changed view angle while the vehicle is turning.

Automatic rearview mirror adjustment systems have been developed that turn the rearview mirror of a motor vehicle coupled with a trailer in response to the wireless signal transmitter mounted on the trailer to compensate for the occlusions of the view field of the rearview mirror caused by the trailer during turns.

Finally, automatic passenger side rearview mirror adjustment systems have been developed that adjust the passenger side rearview mirror into the corrected position based on the knowledge of the driver's position and position of the driver side rearview mirror.

However, none of the conventional systems adjust the rearview mirror in a vehicle automatically according to the position of the face of the driver. Additionally, none of the conventional systems uses the rearview mirror reflection for camera-aided driver analysis such as automatic speech recognition or drowsiness detection in a vehicle.

### SUMMARY OF THE INVENTION

In view of the foregoing and other exemplary problems, drawbacks, and disadvantages of the conventional methods and structures, an exemplary feature of the present invention is to provide a method and an apparatus for automatically adjusting a rearview mirror in a vehicle according to a position of the driver's face.

In accordance with a first exemplary aspect of the present invention, a driver analysis system for a vehicle includes a video camera producing a video signal mounted in or on a body of the vehicle, the video camera having a field of view that includes an internal rearview mirror or an external rearview mirror, and the video camera being positioned such that it sees a face of a driver of the vehicle or a part of the face reflected by the rearview mirror when the mirror is aligned to allow the driver to see behind the vehicle, a processing unit receiving a video signal from the video camera, where the processing unit includes a video grabber/digitizer, which receives the video signal from the camera and produces a sequence of digitized images, a central processing unit, a memory, and an output control line, and a control program, that runs on the processing unit, comprising image recognition algorithms that are capable of detecting the face of the driver in the image sequence. The control program receives the images from the grabber/digitizer and performs a search for the face of the driver reflected in the mirror.

In accordance with a second aspect of the present invention, the driver analysis system further includes a warning device, including one of a warning light and a warning acoustic signaler, that receives the signal from the output control line and issues a warning towards the driver according to the signal, wherein if the face of the driver is not detected by the control program as being present in the input image for a time longer than a predetermined threshold, then the control program issues a warning signal over the output control line of the processing unit.

In accordance with a third aspect of the present invention, the driver analysis system may further include a mirror positioning unit capable of rotating the rearview mirror according to the signals from the output control line of the processing unit, wherein the image recognition algorithms of the control program detects a motion of the face of the driver, including the direction and speed of the face of the driver, and wherein if the face of the driver moves out of a position in which the rearview mirror offers a correct view to the driver, then the control program issues the control signals over the output control line to the mirror positioning unit, so the mirror positioning unit steers the rearview mirror according to the control signals into the position that allows the driver to see the rear scene correctly.

In accordance with a fourth aspect of the present invention, the image recognition algorithms of the control program detects an orientation of the face of the driver, and wherein if the orientation of the face is significantly far vertically or laterally from a nominal orientation, then the control program issues a warning signal over the output control line of the processing unit.

In accordance with a fifth aspect of the present invention, the image recognition algorithms of the control program detect visual symptoms of drowsiness in the image sequence, and if the visual symptoms of drowsiness are detected, then the control program issues a warning signal over the output control line of the processing unit.

In accordance with a sixth aspect of the present invention, the image recognition algorithms of the control program extracts the speech-related information from the image of the lip region of the driver, and the speech-related information is used to activate or suspend a speech-recognition system of the vehicle.

In accordance with a seventh aspect of the present invention the image recognition algorithms of the control program extract the speech-related information from the image of the lip region of the driver, and the speech-related information is used to augment the performance of a speech-recognition system of the vehicle.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1A illustrates a side view of a driver analysis system 100 in accordance with a first exemplary embodiment of the present invention;

FIG. 1B illustrates a top view of the driver analysis system 100 in accordance with the exemplary embodiment depicted in FIG. 1A;

FIG. 2A illustrates a side view of a driver analysis system 200 in accordance with a second exemplary embodiment of the present invention;

FIG. 2B illustrates a top view of the rearview mirror control system 200 in accordance with the exemplary embodiment depicted in FIG. 2A;

FIG. 3A illustrates a side view of a rearview mirror control system 300 in accordance with a fourth exemplary embodiment of the present invention; and

FIG. 3B illustrates a top view of the rearview mirror control system 300 in accordance with the third exemplary embodiment depicted in FIG. 3A.

### DETAILED DESCRIPTION OF EXEMPLARY EMBODIMENTS OF THE INVENTION

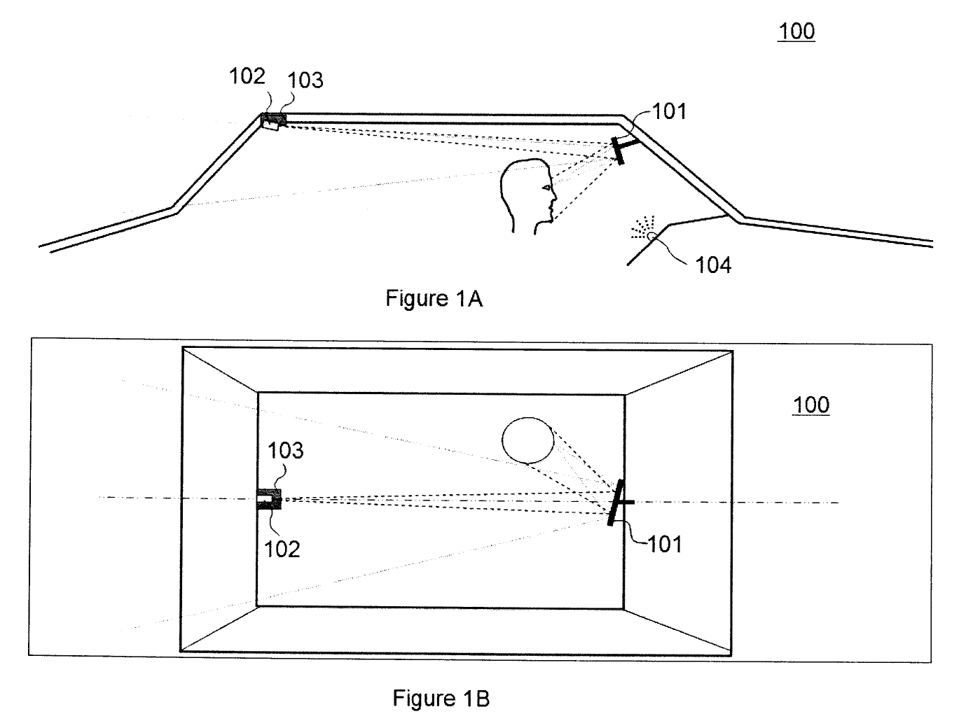

Referring now to the drawings, and more particularly to FIGS. 1A-3A, there are shown exemplary embodiments of the method and structures according to the present invention.

Referring to FIGS. 1A and 1B, a video camera 102 mounted on the ceiling of the vehicle is viewing the driver's face through the interior (or alternatively, on an exterior rearview mirror) rearview mirror 101. A signal from the video camera is received by a processing unit 103, which includes a video grabber/digitizer, a CPU, and an output control line. A control program running on the processing unit includes image recognition algorithms that are capable of detecting the driver's face (e.g., which is reflected by the rearview mirror) in an input image sequence that is captured by the video camera and digitized by the video grabber/digitizer.

If the driver moves his head so that the video camera cannot detect the driver's face for a longer time than a specified time-out period, then the control program issues a warning signal using the output control line. The output control line may be connected to the warning light on the dashboard 104, and/or to an acoustic signaler that warns the driver that the mirror is off the correct position.

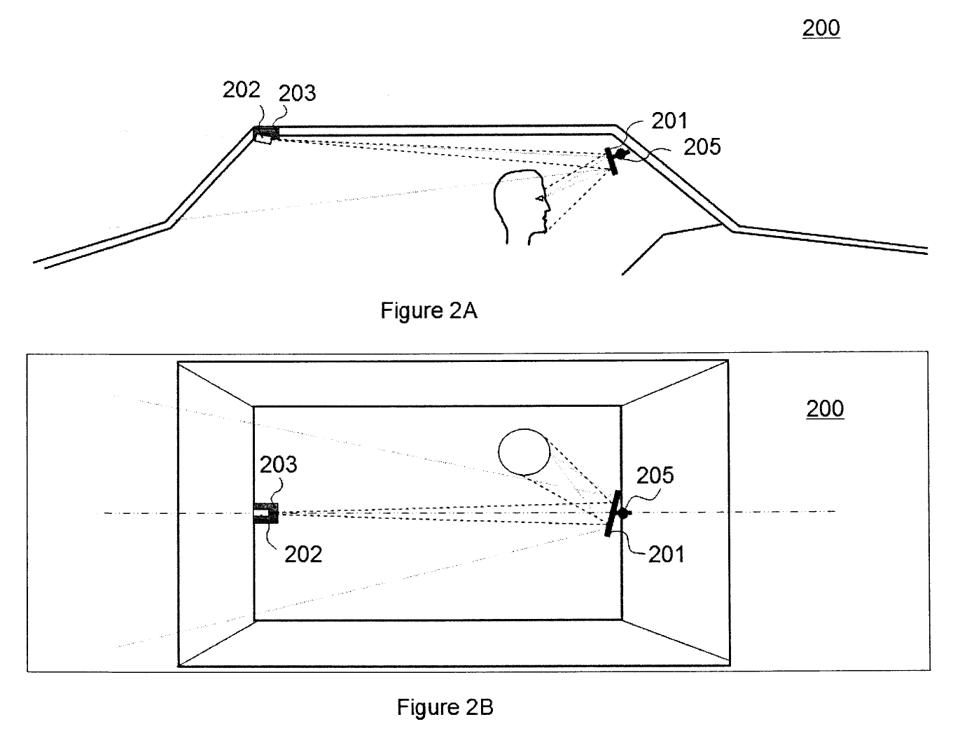

In accordance with the exemplary embodiment depicted in FIGS. 2A and 2B, the rearview mirror is equipped with a controllable positioning unit 205 that is capable of rotating the rearview mirror 201, so the rearview mirror 201 can be adjusted according to the signal from the processing unit 203. The control program includes algorithms that are able to detect the driver's face motion, its direction and speed, in an input image sequence that is captured by the video camera and digitized by the video grabber/digitizer. If the driver moves his head, then the control program detects the speed and direction of the driver's head motion and issues a command for the positioning unit 205 of the rearview mirror 201, using the output control line so the positioning unit 205 positions the rearview mirror 201 so that the driver is able to see the rear scene correctly in his current position.

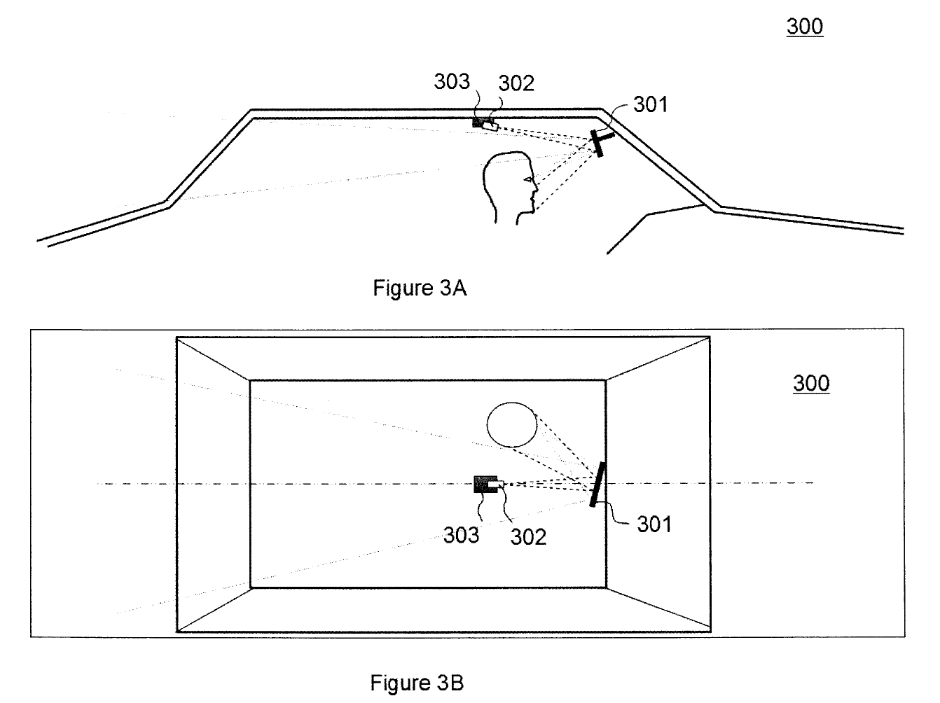

In the exemplary embodiment depicted in FIGS. 3A and 3B, the video camera 302 may be mounted on the ceiling of the vehicle and views the driver's face through the interior rearview mirror 301. The control program is capable of detecting the driver's lip area location in an input image sequence that is captured by the video camera and digitized by the video grabber/digitizer. The visual speech processing system processes the image of the lip area to extract speech-related information and uses this information to activate or suspend a speech-recognition system of the vehicle.

The control program is also capable of detecting the driver's eyes location, extracting visual features related to the drowsiness symptoms and providing a drowsiness detection function.

While the invention has been described in terms of several exemplary embodiments, those skilled in the art will recognize that the invention can be practiced with modification within the spirit and scope of the appended claims. In particular, a vehicle may be an automobile, truck, van, boat, airplane, hovercraft, or other conveyance. The rearview mirror may be center-mounted on the vehicle, to the left of the driver, or to the right of the driver. Furthermore, the video camera may be any suitable CMOS, CCD, vidicon, or other visual sensor and may be interfaced to the computer using analog composite video, S-video, RGB component video, USB, FireWire, Ethernet, CameraLink, or other equivalent transmission means.

Further, it is noted that, Applicants' intent is to encompass equivalents of all claim elements, even if amended later during prosecution.

What is claimed is:

1. A driver analysis system for a vehicle, comprising:
a video camera producing a video signal mounted in or on a body of the vehicle, said video camera having a field of view that includes an internal rearview mirror or an external rearview mirror, and said video camera being positioned such that it sees a face of a driver of the vehicle or a part of the face reflected by the rearview mirror when the mirror is aligned to allow the driver to see behind the vehicle;
a processing unit receiving a video signal from said video camera, said processing unit comprising:
a video grabber/digitizer, which receives said video signal from said camera and produces a sequence of digitized images;
a central processing unit;
a memory; and
an output control line; and
a control program, that runs on said processing unit, comprising image recognition algorithms that are capable of detecting the face of the driver in said image sequence,
wherein the control program receives the images from said grabber/digitizer and performs a search for the face of the driver reflected in the mirror.

2. The driver analysis system according to claim 1, further comprising:
a warning device, comprising one of a warning light and a warning acoustic signaler, that receives the signal from said output control line and issues a warning towards the driver according to the signal,
wherein if said face of said driver is not detected by said control program as being present in the input image for a time longer than a predetermined threshold, then said control program issues a warning signal over the output control line of said processing unit.

3. The driver analysis system according to claim 1, further comprising:
a mirror positioning unit capable of rotating said rearview mirror according to the signals from said output control line of said processing unit,
wherein said image recognition algorithms of said control program detects a motion of the face of the driver, including the direction and speed of the face of the driver, and
wherein if said face of the driver moves out of a position in which the rearview mirror offers a correct view to the driver, then said control program issues the control signals over said output control line to said mirror positioning unit, so the mirror positioning unit steers the rearview mirror according to the control signals into the position that allows the driver to see the rear scene correctly.

4. The driver analysis system according to claim 1, wherein said image recognition algorithms of said control program detects an orientation of the face of the driver, and wherein if said orientation of said face is significantly far vertically or laterally from a nominal orientation, then said control program issues a warning signal over the output control line of said processing unit.

5. A driver analysis system according claim 1, wherein said image recognition algorithms of said control program detect visual symptoms of drowsiness in said image sequence, and
wherein if the visual symptoms of drowsiness are detected, then the control program issues a warning signal over the output control line of the processing unit.

6. The driver analysis system according to claim 1, wherein said image recognition algorithms of said control program extracts the speech-related information from the image of the lip region of the driver, and
wherein said speech-related information is used to activate or suspend a speech-recognition system of the vehicle.

7. The driver analysis system according to claim 1, wherein said image recognition algorithms of said control program extract the speech-related information from the image of the lip region of the driver, and wherein said speech-related information is used to augment the performance of a speech-recognition system of the vehicle.
